(19) United States
(12) Patent Application Publication
(10) Pub. No.: US 2010/0310920 A1
(43) Pub. Date: Dec. 9, 2010

(54) CENTER PIN FOR SECONDARY BATTERY AND SECONDARY BATTERY INCLUDING THE SAME

(75) Inventors: Seok-Gyun Chang, Suwon-si (KR); Jung-Ho Kim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/796,575

(22) Filed: Jun. 8, 2010

(30) Foreign Application Priority Data
Jun. 9, 2009 (KR) 10-2009-0051100

(51) Int. Cl. H01M 10/50; H01M 2/08

(52) U.S. Cl. 429/120; 429/185

(57) ABSTRACT

A center pin for a secondary battery, and a secondary battery including the same, are disclosed. The center pin is capable of efficiently preventing generation of heat, ignition and explosion of the secondary battery as may be caused by overcharge or exposure to high temperatures. The center pin comprises a body having a predetermined length, a fluid inserted into the body, and sealing members for sealing the body. The secondary battery comprises an electrode assembly including a positive electrode plate, a negative electrode plate and a separator interposed between the positive electrode plate and the negative electrode plate, a center pin comprising a fluid disposed in the electrode assembly, a can accommodating the electrode assembly and the center pin, and a cap assembly sealing the can.

### CROSS-REFERENCE TO RELATED APPLICATIONS

This application claims the benefit of Korean Patent Application No. 2009-0051100, filed Jun. 9, 2009, the disclosure of which is incorporated herein by reference in its entirety.

### BACKGROUND

1. Field

The present disclosure relates to a center pin for a secondary battery, and a secondary battery including the same, and more particularly to a center pin for a secondary battery capable of efficiently preventing generation of heat, ignition and explosion of the secondary battery caused by overcharge or exposure to high temperatures, and a secondary battery including the same.

2. Description of the Related Technology

In recent times, compact and lightweight mobile electronic appliances such as cellular phones, notebook computers, camcorders, etc., have been actively developed and manufactured. In order to operate the mobile electronic appliances even where there is no separate power supply, a battery pack is typically built-in. The battery pack may include a nickel-cadmium (Ni—Cd) battery, a nickel-hydrogen (Ni—MH) battery, and a lithium (Li) battery, and may generally be a secondary battery, which can be repeatedly charged and discharged.

Among them, the lithium (Li) secondary battery has an operating voltage about three times larger and an energy density per unit weight larger than that of the Ni—Cd battery or the Ni—MH battery, and thus, is widely used for mobile electronic appliances.

The lithium secondary battery may be classified as a lithium ion battery using a liquid electrolyte or a lithium polymer battery using a polymer electrolyte, depending on the kind of electrolyte, or classified as a prismatic type battery, a cylinder type battery, and a pouch type battery, depending on the shape thereof.

The cylinder type secondary battery generally includes an electrode assembly wound in a cylindrical manner, a center pin disposed in the electrode assembly, a can for accommodating the electrode assembly, the center pin and an electrolyte enabling lithium ions to move within a space in the electrode assembly, and a cap assembly for sealing the can.

Here, the electrode assembly typically includes a positive electrode plate having a positive electrode collector with positive electrode active materials applied thereto and a positive electrode tab electrically connected to one side of the positive electrode collector, a negative electrode plate having a negative electrode collector with negative electrode active materials applied thereto and a negative electrode tab electrically connected to one side of the negative electrode collector, and a separator disposed between the two electrode plates.

The electrolyte serves to enable lithium ions generated by electrochemical reactions to be delivered in the positive and negative electrode plates of the electrode assembly while the battery is charged or discharged. The electrolyte may be a non-aqueous organic electrolyte, such as a compound of lithium salt and high-purity organic solvents. Alternatively, the electrolyte may be a polymer electrolyte.

The center pin typically prevents the electrode assembly from being deformed when the electrode assembly is charged or discharged, and includes a body having a predetermined length, in which a hole is formed in a longitudinal direction to provide a path for delivering any gases, which may be caused by overcharge, exposure to high temperatures or internal abnormality generated around the electrode assembly, toward the cap assembly.

The cap assembly can prevent the heat generation, ignition and explosion of the secondary battery when internal abnormalities occur, such as damage of the electrode assembly caused by overcharge, high-temperature or external impact, and can include a safety vent deformed or broken by the gas that is generated around the electrode assembly and moved by the center pin.

However, although such a secondary battery seals a center pin, and includes a non-flammable or gasification member inserted into the sealed space to minimize unnecessary space and to prevent heat generation, ignition and explosion of the secondary battery as may be caused by overcharge or exposure to high temperatures, the non-flammable or gasification member may have low fluidity. Therefore, heat generation, ignition and explosion of the secondary battery may not be efficiently prevented.

### SUMMARY

Embodiments of the present invention provide a center pin for a secondary battery capable of efficiently preventing heat generation, ignition and explosion of a secondary battery as may be caused by internal abnormalities of an electrode assembly due to overcharge, exposure to high temperatures or external impact, and a secondary battery including the same.

According to one embodiment, a center pin for a secondary battery comprises a body having a predetermined length; a fluid inserted into the body; and sealing members for sealing the body.

According to another embodiment, a secondary battery comprises: an electrode assembly comprising a positive electrode plate, a negative electrode plate and a separator interposed between the positive electrode plate and the negative electrode plate; a center pin comprising a fluid disposed in the electrode assembly; a can accommodating the electrode assembly and the center pin; and a cap assembly sealing the can.

### BRIEF DESCRIPTION OF THE DRAWINGS

Various embodiments are described in further detail below with reference to the accompanying drawings. It should be understood that various aspects of the drawings may have been exaggerated for clarity:

FIG. 1A is an exploded perspective view of a secondary battery according to an embodiment of the present invention;

FIG. 1B is a cross-sectional view of a secondary battery according to an embodiment of the present invention;

FIG. 2 is a cross-sectional view of a center pin of a secondary battery according to an embodiment of the present invention;

FIG. 3 is a cross-sectional view illustrating another configuration of a center pin included in a secondary battery according to an embodiment of the present invention;

FIGS. 4 and 5 are graphs illustrating the operating time of a CID and the highest internal temperature of a secondary battery when secondary batteries according to an embodiment and conventional secondary batteries using conventional center pins are overcharged; and

FIGS. 6 and 7 are graphs illustrating the operating time of a CID and the highest internal temperature of a secondary battery when secondary batteries according to an embodiment and conventional secondary batteries using conventional center pins are exposed to high temperature.

### DETAILED DESCRIPTION

Embodiments of the present invention will now be described more fully hereinafter with reference to the accompanying drawings. In the drawings, the same reference numerals are used to denote the same elements. This invention may, however, be embodied in different forms and should not be construed as limited to the embodiments set forth herein. When it is described that a part is “connected” to another part, it may be construed as meaning “electrically connected” with a device interposed therebetween as well as “directly connected.” In addition, the lengths or thicknesses of layers and regions may be exaggerated for clarity.

### First Embodiment

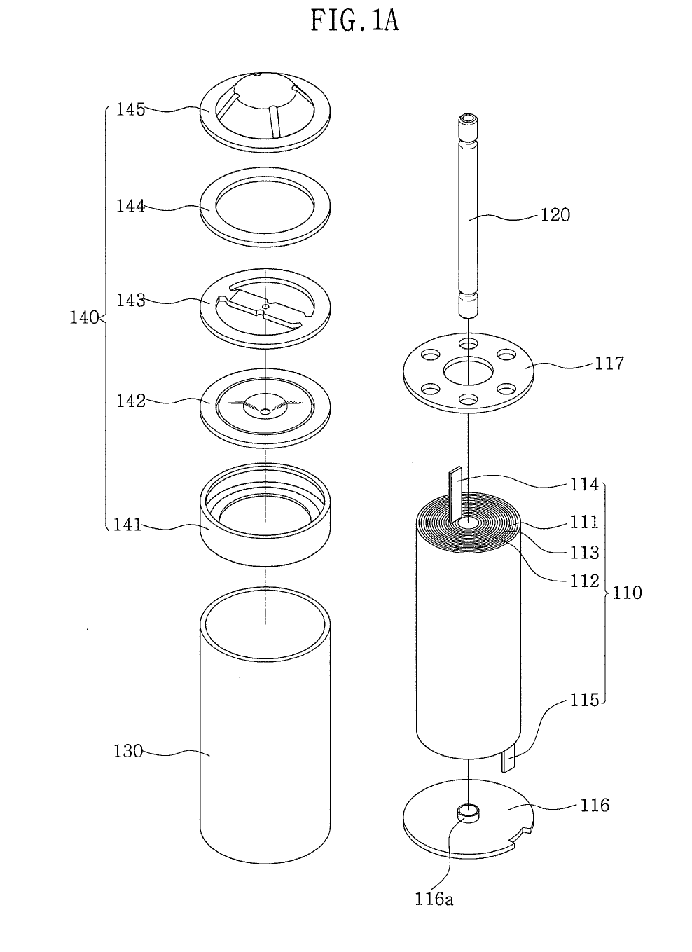

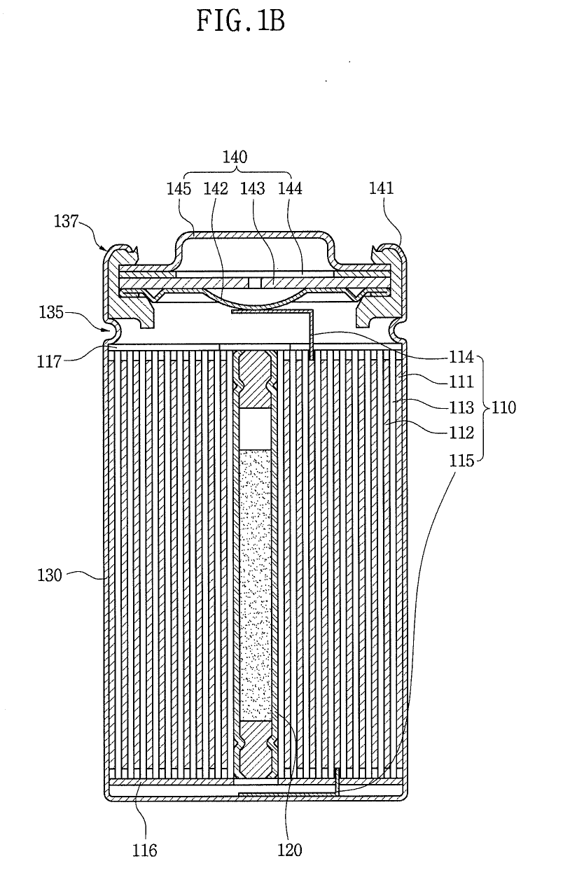

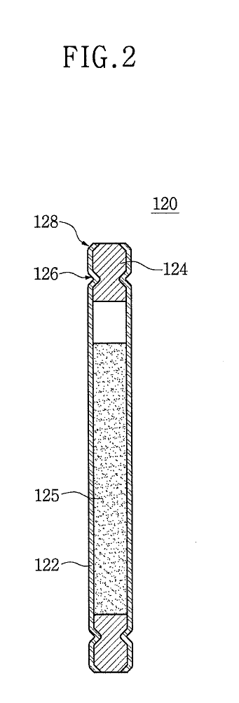

FIG. 1A is an exploded perspective view of a secondary battery according to an embodiment, FIG. 1B is a cross-sectional view of a secondary battery according to an embodiment and FIG. 2 is a cross-sectional view of a center pin of a secondary battery according to an embodiment of the present invention.

Referring to FIGS. 1A, 1B and 2, a secondary battery according to an embodiment of the present invention includes an electrode assembly 110, a center pin 120 disposed in the electrode assembly 110, a can 130 for accommodating the electrode assembly 110, the center pin 120 and an electrolyte (not shown), and a cap assembly 140 for sealing the can 130.

The electrode assembly 110 can include: a positive electrode plate 111 having a positive electrode collector (not shown) with positive electrode active materials (not shown) applied thereto and a positive electrode tab 114 electrically connected to one side of the positive electrode collector and protruding toward the cap assembly 140; a negative electrode plate 112 having a negative electrode collector (not shown) with negative electrode active materials (not shown) applied thereto and a negative electrode tab 115 electrically connected to one side of the negative electrode collector and protruding in an opposite direction to the positive electrode tab 114; and a separator 113 disposed between the positive electrode plate 111 and the negative electrode plate 112.

Here, while it is described that the positive electrode tab 114 of the electrode assembly 110 protrudes in the opposite direction to the cap assembly 140 the negative electrode tab 115 of the electrode assembly 110 may protrude toward the cap assembly 140, and the positive electrode tab 114 may protrude in the opposite direction toward the negative electrode tab 115.

Typical examples of the positive electrode active material may include lithium-transition metal oxides, such as LiCoO₂, LiNiO₂, LiMnO₂, LiMn₂O₄, and LiNi_{1-x-y}COₓM_{y}O₂ (0≦x≦1, 0≦y≦1, 0≦x+y≦1, M is a metal, such as Al, Sr, Mg, or La) or a lithium calchogenide compound. The negative electrode active material may include a carbon material, such as crystalline or amorphous carbon, a carbon composite or a carbon fiber, a lithium metal or a lithium alloy.

The positive or negative electrode collector may be formed of a material selected from the group consisting of stainless steel, nickel, copper, aluminum and an alloy thereof. Preferably, the positive electrode collector may be formed of aluminum or an aluminum alloy, and the negative electrode collector may be formed of copper or a copper alloy to maximize the efficiency of the electrode assembly 110.

The separator 113 may be disposed between the positive electrode plate 111 and the negative electrode plate 112, prevent an electrical short between the positive electrode plate 111 and the negative electrode plate 112, and enable lithium ions to move between the two electrode plates. The separator 113 may be formed of a polyolefin-based polymer layer such as polyethylene (PE), polypropylene (PP) or a multilayer thereof, a porous layer including a ceramic material, or a porous layer including a polyolefin-based polymer layer and ceramic material.

Here, the ceramic material may include a material selected from the group consisting of silica (SiO₂), alumina (Al₂O₃), zirconium oxide (ZrO₂), and titanium oxide (TiO₂), insulating nitride, hydroxide, alkoxide and ketone of each of zirconium, aluminum, silicon, and titanium.

The electrolyte may function to enable lithium ions generated by electrochemical reactions to be delivered in the positive electrode plate 111 and the negative electrode plate 112 of the electrode assembly 110 during charging and discharging. The electrolyte may be a non-aqueous organic electrolyte, such as a compound of lithium salt and high-purity organic solvents, or a polymer electrolyte.

The can 130 may be formed in the shape of a cylinder having a predetermined radius, and may be formed to have an open top portion and a circular bottom surface, so that the electrode assembly 110, the center pin 120 and the electrolyte can be accommodated. The can 130 may be formed of a metal material such as aluminum, an aluminum alloy or stainless steel, which is light and flexible, so that the can 130 can serve as a negative terminal when the negative electrode tab 115 protruding in the opposite direction to the positive electrode tab 114 is electrically connected to the bottom surface of the can 130.

The can 130 may include a beading portion or indentation 135, in which an outer circumferential surface of the corresponding can 130 between the cap assembly 140 and the electrode assembly 110 protrudes inward by a predetermined distance. The can 130 may also include a crimping portion 137, in which upper ends of the can 130 are bent inwardly with respect to the cap assembly 140. The indentation 135 and crimping portion 137 can prevent the cap assembly 140 from being separated from the can 130 and prevent the electrode assembly 110 from moving vertically due to external force after the can 130 is sealed by the cap assembly 140.

Further, in order to prevent an unnecessary electrical connection between the electrode assembly 110 and the cap assembly 140, and between the electrode assembly 110 and the can 130, an upper insulating plate 117 disposed on the electrode assembly 110 may be included and may have one or more holes therein to enable a gas generated around the electrode assembly 110 to move. A lower insulating plate 116 disposed at a lower portion of the electrode assembly 110 may be further included.

The cap assembly 140 can include an upper cap 145 combined with the opening on top of the can 130 to seal the can 130 and electrically connected to an external terminal (not shown). The cap assembly 140 can also include a safety vent 142 electrically connected to a positive electrode tab 114 of the electrode assembly 110, and may be deformed or burst to discharge a gas when the gas generated around the electrode assembly 110 causes internal pressure to be a predetermined level or higher. The cap assembly 140 can also include a current interrupt device (CID) 143 disposed on the safety vent 142, and may be damaged or broken by the safety vent 142 that is deformed or burst from the internal pressure, and may interrupt an electrical connection between the electrode assembly 110 and the external terminal. The cap assembly 140 can also include a gasket 141 insulating the cap assembly 140 from the can 130.

Here, the cap assembly 140 may further include a ring-shaped positive temperature coefficient (PTC) thermistor 144 disposed between the CID 143 and the upper cap 145 in order to prevent flow of possible over-currents between the electrode assembly 110 and the external terminal.

The center pin 120 may be disposed in the electrode assembly 110 to prevent the electrode assembly 110 from being deformed during charging and discharging, and may provide a path for delivering any gases generated around the electrode assembly 110, from internal abnormalities occur due to overcharge, exposure to high temperatures or external impact, toward the cap assembly 140. As shown in FIG. 2, the center pin 120 may include a body 122 having a predetermined length, a fluid such as water 125 inserted into the body 122, and sealing members 124 configured to seal the body 122 and disposed at both ends of the body 122. Here, while the sealing members 124 are described as disposed at both ends of the body 122 to entirely seal the body 122 according to one embodiment, the sealing member 124 may be disposed in the center pin 120 to partially seal the body 122 with water 125 inserted into a region sealed by the sealing member 124 according to other embodiments.

In addition, while the fluid 125 inserted into the body 122 may include any kind of water, it may be one of purified water, distilled water and pure water to prevent unnecessary chemical reactions caused by an additive.

The body 122 may have a predetermined length in the direction of the thickness of the electrode assembly 110, and a hole therein in a longitudinal direction to serve as a path for any gases generated around the electrode assembly 110. Here, while the body 122 may be formed of an insulating material such as polybutylene terepthalate (PBT), it may also be formed of a metal material, such as steel, stainless steel SUS, aluminum and an aluminum alloy to facilitate the delivery of the gas even in high temperature states such as during overcharge or exposure to high temperatures.

When the sealing members 124 are disposed at both ends of the body 122, a longitudinal end 128 of the body 122 may be bent toward a center portion of the body 122, so that the sealing members 124 are prevented from being detached.

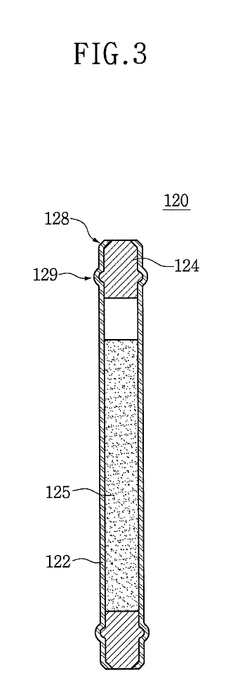

Moreover, a cooling fluid such as water 125 inserted into the body 122 can delay response of the electrode assembly 110, and thus the body 122 may be formed to have one or more indendations 126 on a region in contact with the sealing members 124. Accordingly, the water 125 inserted into a region sealed by the sealing members 124 can be prevented from flowing out at the time when no internal abnormality occurs. Here, in order to improve tightness by the sealing members 124, as illustrated in FIG. 3, the body 122 may be formed to have one or more protrusions 129 on a region in contact with the sealing member 124. When internal abnormalities occur, the sealing member 124 may be melted or broken to enable the body 122 of the center pin 120 to serve as a path of the gas generated around the electrode assembly 110. The sealing member 124 may be formed of a polymer resin such as polyethylene (PE), polypropylene (PP) or polyethyleneterephthalate (PBT) in order for the water 125 inserted into the body 122 to be introduced into the electrode assembly 110. Furthermore, taking into account temperatures at which internal abnormalities of a secondary battery generally occur, the sealing member 124 may be melted or broken at a temperature, e.g., from about 100° C. to about 130° C.

Therefore, when overcharge or exposure to high temperatures of a secondary battery causes internal abnormalities of the secondary battery, the inside of the center pin is sealed using the sealing member, and water of high fluidity inserted into the region sealed by the sealing member can efficiently delay response and activation of the electrode assembly.

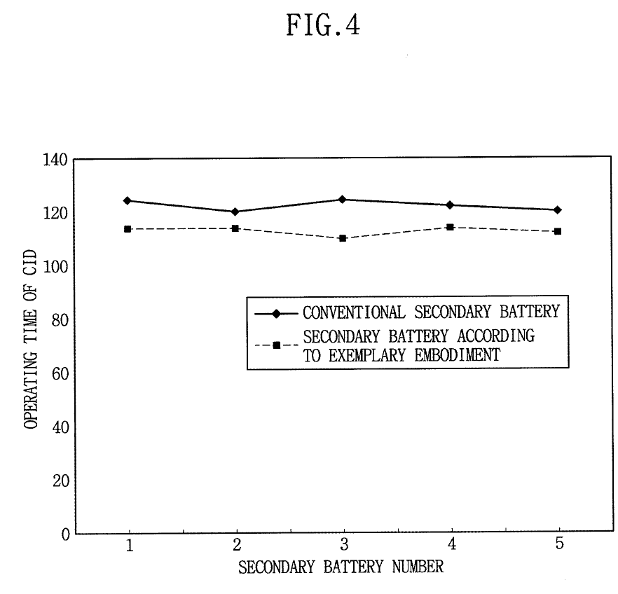

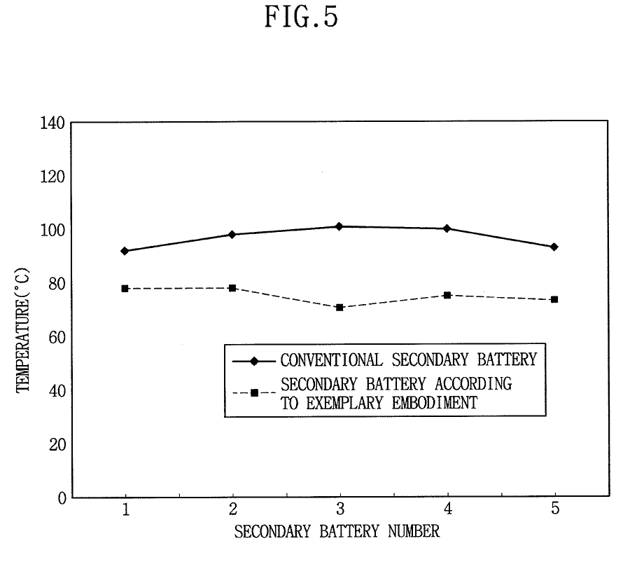

FIGS. 4 and 5 are graphs in which the operating time of a CID and the highest internal temperature of a secondary battery were measured when five secondary batteries according to an embodiment of the present invention, and five conventional secondary batteries including conventional center pins, were respectively overcharged. Here, the conventional center pin includes sealing members disposed at both ends of the body in order to seal the body and the inside of the body, and denotes a center pin which has a hollow body.

Referring to FIGS. 4 and 5, compared to the conventional secondary battery including a conventional center pin, the secondary battery according to an embodiment of the present invention exhibited faster CID operating time and lower highest internal temperature of the secondary battery.

In general, increasing the CID operating time and lowering the highest internal temperature of a secondary battery mean that the internal heat of a secondary battery is efficiently emitted and an electrolyte that intensively reacts with charged positive and negative electrodes at a high temperature is exhausted within a short time, so that response of an electrode assembly is efficiently delayed.

Therefore, compared to the conventional secondary battery, it is observed that the secondary battery according to embodiments of the present invention can efficiently delay response of the electrode assembly due to internal abnormalities as caused by overcharge or exposure to high temperatures.

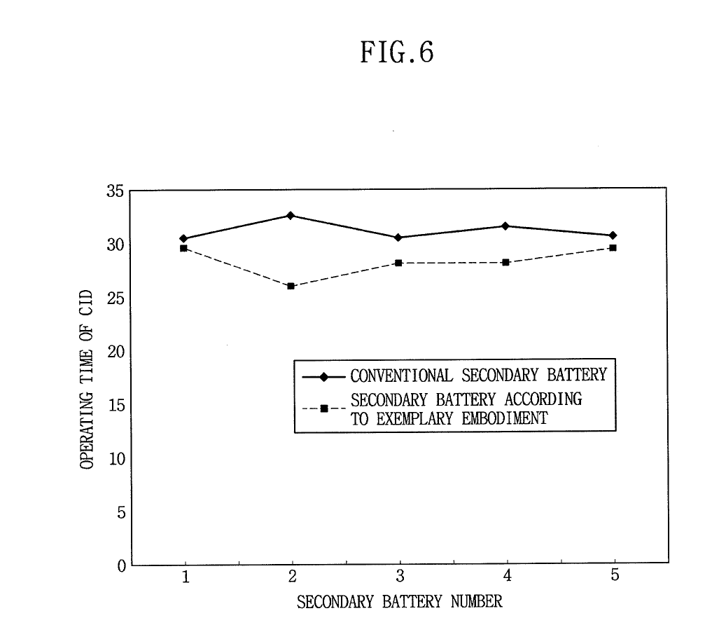

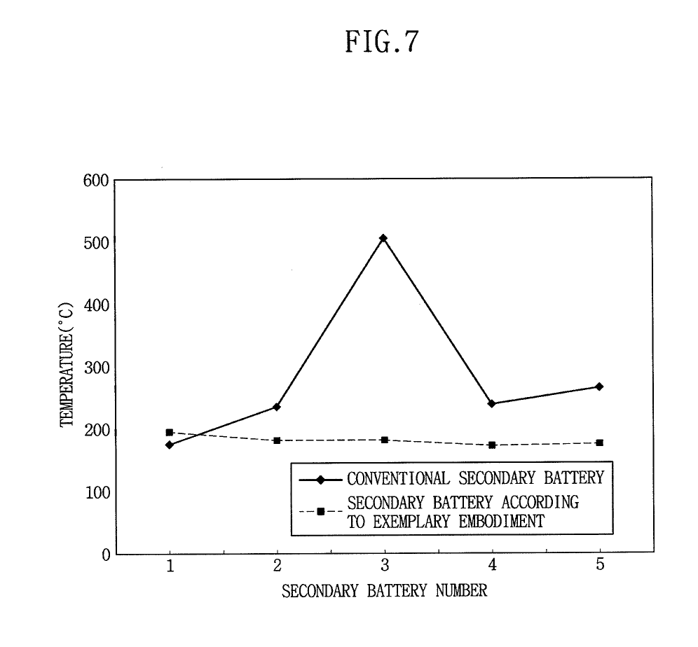

FIGS. 6 and 7 are graphs showing measurements of the operating time of a CID and the highest internal temperature of a secondary battery when high-temperature heat exposure experiments are performed on five secondary batteries according to an embodiment of the present invention and five conventional secondary batteries including conventional center pins. Here, the high-temperature heat exposure experiment continuously exposes a secondary battery to an environment at a temperature of 100° C. or higher.

Referring to FIGS. 6 and 7, a secondary battery according to an embodiment of the present invention exhibited a faster CID, and lower highest internal temperature of the secondary battery, compared to a conventional secondary battery including a conventional center pin.

As described above, increasing the CID operating time and lowering the highest internal temperature of the secondary battery mean that the response of an electrode assembly is efficiently delayed. Therefore, it has been shown that the response of the electrode assembly is more efficiently delayed for embodiments of the present invention as compared to the conventional secondary battery, when internal abnormalities of the secondary battery are caused by exposure to high-temperature heat.

Consequently, in the secondary battery according to embodiments of the present invention, the inside of a center pin may be sealed by a sealing member, a fluid such as water may be inserted into a region sealed by the sealing member. As a result, when internal abnormalities are caused by overcharge or exposure to high-temperature heat, the fluid such as water may be introduced into an electrode assembly, so that response and activation of the electrode assembly can be efficiently delayed.

Therefore, in a center pin for a secondary battery and a secondary battery including the same according to embodiments of the present invention, a fluid such as water may be inserted into the center pin to prevent internal temperature of the secondary battery from rising excessively. Also, when overcharge, exposure to high temperatures or external impact causes internal abnormalities in an electrode assembly, a cooling fluid such as water may be introduced into the electrode assembly, so that response of the electrode assembly is delayed. As a result, generation of heat, ignition and explosion of the secondary battery can be efficiently prevented.

Although embodiments of the present invention have been described with reference to certain exemplary embodiments thereof, it will be understood by those skilled in the art that a variety of modifications are possible without departing from the spirit and scope of the present invention defined by the appended claims, and their equivalents.

What is claimed is:

1. A center pin for a secondary battery, comprising:
a body having a predetermined length;
a fluid inserted into the body; and
sealing members for sealing the body.

2. The center pin of claim 1, wherein the sealing members are disposed at both ends of the body.

3. The center pin of claim 2, wherein the body includes a longitudinal end that is bent toward a center region of the body.

4. The center pin of claim 1, wherein the fluid is a water selected from the group consisting of purified water, distilled water and pure water.

5. The center pin of claim 1, wherein the body comprises a metal material.

6. The center pin of claim 5, wherein the body comprises a material selected from the group consisting of steel, stainless steel, aluminum and an aluminum alloy.

7. The center pin of claim 1, wherein the sealing member comprises a polymer resin.

8. The center pin of claim 7, wherein the sealing member comprises a material selected from the group of polyethylene, polypropylene and polyimide.

9. The center pin of claim 1, wherein the body comprises one or more indentations or protrusions on a region that is in contact with the sealing member.

10. A secondary battery, comprising:
an electrode assembly comprising a positive electrode plate, a negative electrode plate and a separator interposed between the positive electrode plate and the negative electrode plate;
a center pin comprising a fluid disposed in the electrode assembly;
a can accommodating the electrode assembly and the center pin; and
a cap assembly sealing the can.

11. The secondary battery of claim 10, wherein the center pin has a predetermined length and further comprises:
a body, where the fluid is inserted in the body; and
sealing members for sealing the body.

12. The secondary battery of claim 11, wherein the sealing members are disposed at both ends of the body.

13. The secondary battery of claim 12, wherein the body includes a longitudinal end that is bent toward a center region of the body.

14. The secondary battery of claim 11, wherein the body includes one or more beading portions or protrusions on a region that is in contact with the sealing member.

15. The secondary battery of claim 11, wherein the body comprises a metal material.

16. The secondary battery of claim 15, wherein the body comprises a material selected from the group consisting of steel, stainless steel, aluminum and an aluminum alloy.

17. The secondary battery of claim 11, wherein the sealing member comprises a polymer resin.

18. The secondary battery of claim 17, wherein the sealing member comprises a material selected from the group consisting of polyethylene, polypropylene and polyimide.

19. The secondary battery of claim 11, wherein the sealing member is melted or broken at a temperature from about 100° C. to about 130° C.

20. The secondary battery of claim 10, wherein the water is selected from the group consisting of purified water, distilled water and pure water.

21. A secondary battery, comprising:
an electrode assembly;
a center pin disposed in the electrode assembly, wherein the center pin includes a cooling fluid; and
a can for housing the electrode assembly and the center pin.

22. The secondary battery of claim 21, wherein the cooling fluid comprises water.

23. The secondary battery of claim 21 further comprising sealing members disposed at both ends of the center pin and sealing the water within the center pin.

24. The secondary battery of claim 21 further comprising protrusions disposed at both ends of the center pin.

25. The secondary battery of claim 21 further comprising indentations disposed at both ends of the center pin.
